(19) United States
(12) Patent Application Publication
(10) Pub. No.: US 2004/0026808 A1
(43) Pub. Date: Feb. 12, 2004

(54) Method for the production of faithfully-reproduced medical implants and epiprostheses and said implants and epiprostheses

(76) Inventors: Peter Litschko, Naumburg (DE); Thomas Korbs, Hermsdorf (DE); Sebastien Nagel, Jena (DE); Ralf Schied, Naumburg (DE)

Correspondence Address: JORDAN AND HAMBURG LLP, 122 EAST 42ND STREET, SUITE 4000, NEW YORK, NY, 10168, US

(21) Appl. No.: 10/332,214

(22) PCT Filed: Jul. 4, 2001
(86) PCT No.: PCT/EP01/07651

(30) Foreign Application Priority Data
Jul. 4, 2000 (DE) 100 33 313.3

(51) Int. Cl. B29C 33/40

(52) U.S. Cl. 264/40.1; 264/219; 264/319; 700/197; 700/98; 249/117

(57) ABSTRACT

The invention relates to a method for the production of faithfully-reproduced medical implants (12) and epiprostheses, whereby initially a virtual modeln (11) is produced from extant data on a patient. Said virtual model (11) is converted into the concrete negative thereof (15) into which the material (14) for the implant/epiprosthesis is introduced.

The invention relates to a method for faithfully reproducing medical implants and epiprostheses and to implants and epiprostheses produced thereby according to the class of the claims. When there is reference in the following specification and claims to implants, epiprostheses are basically included.

The production of implants to epiprostheses, which are provided with their final form during or before an operation, has long been known in medicine. From U.S. Pat. Nos. 4,097,935 and 4,976,737, the use of metal nets or metal plates, which can be molded or processed to a limited degree, and also the use of manually deformable materials as implants is known. In other words, the implant is shaped, processed and adapted during the surgery by the treating surgeon. Frequently however, the results are not optimum from a functional as well as an esthetic point of view, since the implants or epiprostheses must be produced strictly manually, using the simplest of tools.

Furthermore, it is known that a 3-D model can be generated from the data of image-producing methods of examining a patient and that a positive implant may be designed virtually at the computer, using constructive methods.

The invention is based on the objective, of starting out from existing data of a patient, and producing individual medical implants from suitable materials as well as individually adapted implants accurately in a relatively simple matter, the implants satisfying higher functional and esthetic requirements.

Pursuant to the invention, this objective is accomplished by the characterizing distinguishing features of claim 1. The virtual, 3-dimensional model of the medical implant is formed in a known manner from existing data of the patient or by some other type of construction. It forms a device, which is surrounded by the future implant volume (hollow mold). The individual hollow mold is produced by evaluating the patient data, which has been made available or the data of the virtual implant. From this data, data for the computer-controlled production (such as CNC milling) is derived. The starting materials for producing the hollow mold depend on the later material for the implant, which preferably consists of hollow metal or ceramic forms for the design of implants from exogenous materials and biopassive glass for endogenous materials.

Subsequently, the actual implant material is introduced into the hollow mold, which, for easier demolding, may be separable or also consist of one piece and of different materials. The implant material may be an exogenous material (metals, ceramics, plastics, etc.) in a powdery or liquid state, as well as an endogenous material (such as endogenous cells in a nutrient solution).

In the case of an exogenous material, the finished implant, after the final technical steps of the process (such as sintering, pressing, temperature treatment, etc.), is removed from the mold and optionally finished. The application of technological processes, such as foaming the material during the molding, has special significance for giving the individual implant faithfully reproduced properties (bone-like structures). If the material is endogenous, the individual implant grows in the negative mold, taking into consideration biological and physical parameters, into an implant of an endogenous material. For this purpose, for example, endogenous tissue cells (cartilage, bones, etc.) are first of all taken from the patient and these, together with appropriate nutrient solution and possibly other materials (such as porous support bodies from materials, which can be absorbed and replaced by the body) are introduced into the developed and individually produced negative mold, which is configured as a hollow mold and produced from a material which is compatible with the implant material. The implant is developed thus from the components. In this way, the individual medical implant can be produced under esthetic and functional aspects in any shape, size and complicatedness from various different materials and natural products. A further advantage consists of the individual, objective molding, by taking into consideration the patient data, which can vary greatly, in the configuration of the hollow mold for the implant.

The invention is described in greater detail below by means of the diagrammatic drawing, in which

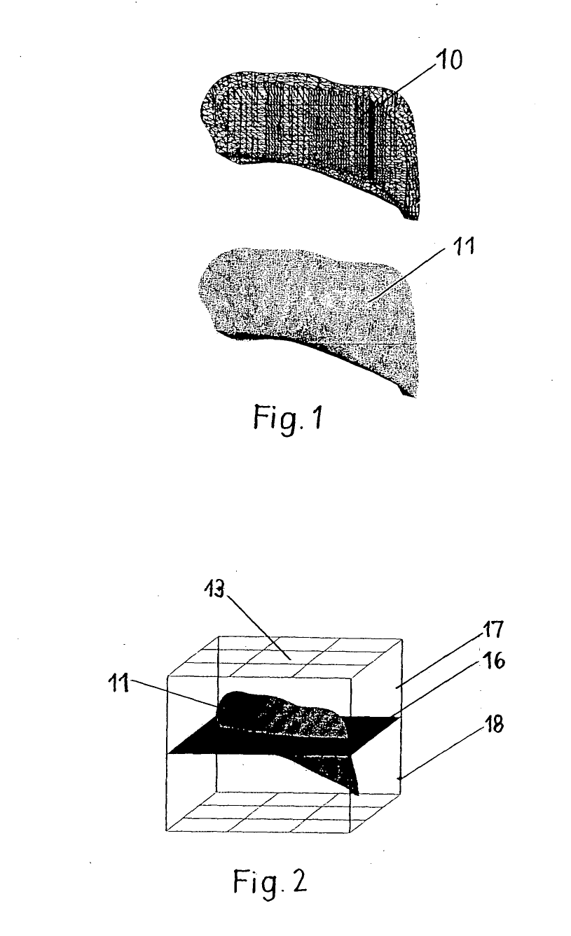

FIG. 1 shows the construction of a virtual model of the implant,

FIG. 2 shows the production of a negative mold for the implant,

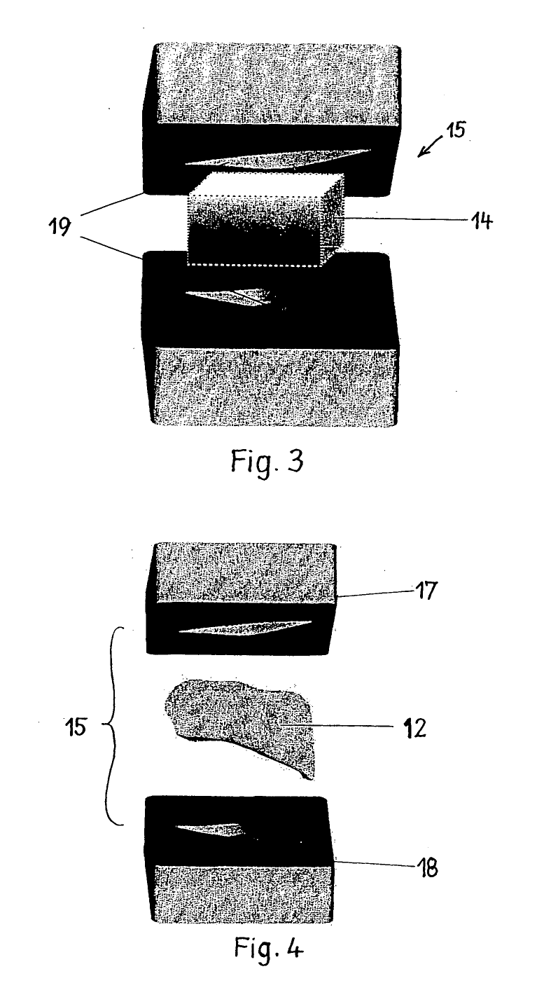

FIG. 3 shows the filling of the negative mold with implant material and

FIG. 4 shows the finished implant.

Starting out from the data of the medical imaging process, such as computer tomography, a fitting implant model is designed individually for a patient by known methods by means of a computer as a 2-dimensional model 10 and converted into a 3-dimensional model 11 (FIG. 1). For preparing a concrete, negative mold 15 of an implant 12, which is to be produced, a volume 13, surrounding the implant model 11, is ascertained by computer (FIG. 2). The negative mold basically is described and designed by forming the difference between the surrounding volume 13 and the 3-dimensional model 11. In order to enable implant material 14 (FIG. 3) to be introduced into the negative mold, the construction of FIG. 2 is divided into mold parts 17, 18 by at least one sectional plane 16. The construction data, so obtained for the mold parts 17, 18, are converted into a data format, which is suitable for the production process. For example, the data is converted into control data for a computer-controlled milling machine, which is not shown.

After the negative mold 15, consisting of the mold parts 17, 18, is completed, the required implant material 14, such as a (plastic) powder or powder-binder mixture, is introduced into the cavity 19 of the negative mold 15 and pressed.

Endogenous cells, nutrient solution and support material can also be introduced into the cavity 19 of the negative mold 15, induced growth of the implant material coming about in the mold.

The starting material, suitable for the area of application, is selected for producing the negative mold 15 and is matched to the implant material 14. For example, hollow molds of metal or ceramic are used to produce implants from exogenous materials and hollow molds from biopassive glass are used for implants of endogenous materials.

The negative mold, which may be in one piece or consist of parts, may also have boreholes or accesses, in order to be able to supply liquid implant materials or nutrient solutions, the latter stimulating or enabling the growth of an implant in the cavity 19 and optionally having to be supplied continuously.

At the conclusion of the molding process, the mold parts 17, 18 are swung open and the implant 12 is removed from the negative mold 15. If necessary, the implant 12 can also be subjected to a finishing treatment, such as sintering.

All distinguishing features, described in the specification and in the claims below and represented in the drawing, may be essential to the invention individually as well as in any combination with one another.

List of Reference Symbols

| | |
|---|---|
| 10 | 2-Dimensional model |
| 11 | 3-Dimensional model |
| 12 | Implant |
| 13 | Volume |
| 14 | Implant material |
| 15 | Negative mold |
| 16 | Sectional plane |
| 17, 18 | Mold parts |
| 19 | Cavity |

1. Method for the production of faithfully reproduced medical implants, for which a virtual model is prepared from the existing data of a particular patient, characterized in that the virtual model is converted into a concrete negative mold, into which the implant material is introduced.

2. The method of claim 1, characterized in that the implant material is exogenous material.

3. The method of claim 1, characterized in that the implant material is endogenous material.

4. The method of claim 2, characterized in that the exogenous material is powdery and pressed.

5. The method of claim 2, characterized in that the exogenous material is in a liquid state.

6. The method of claim 2, characterized in that the exogenous material is foamed during the molding process.

7. The method of claim 3, characterized in that endogenous tissue cells are introduced into the negative mold together with an appropriate nutrient solution and, optionally, further absorbable materials.

8. A negative mold, which is produced according to the claims 1-7, characterized in that it is a hollow mold and produced from a material, which is compatible with the implant material.

9. The negative mold of claim 8, characterized in that it consists of parts.

10. The negative mold of claim 9, characterized in that the individual parts of the mold consist of different materials.
